(19) United States
(12) Patent Application Publication
(10) Pub. No.: US 2025/0225471 A1
(43) Pub. Date: Jul. 10, 2025

(54) DELIVERY SYSTEM AND METHOD OF SECURELY DELIVERING A PACKAGE

(71) Applicant: Matthew Warner, Los Angeles, CA (US)

(72) Inventor: Matthew Warner, Los Angeles, CA (US)

(21) Appl. No.: 19/065,983

(22) Filed: Feb. 27, 2025

Related U.S. Application Data
(63) Continuation-in-part of application No. 18/981,410, filed on Dec. 13, 2024.
(60) Provisional application No. 63/610,450, filed on Dec. 15, 2023.

(51) Int. Cl. G06Q 10/0836; B65G 1/16; G07C 9/00

(52) U.S. Cl. CPC G06Q 10/0836; B65G 1/16; G07C 9/00896

(57) ABSTRACT

Delivery system and method for securely delivering a package including housings or storage units positioned at a wall, door, or a roof of a structure. The delivery system includes a hatch operatively connected to the storage units. The delivery system includes sensors configured to detect presence of a package in the storage units. The delivery system includes a controller operatively connected to the storage units, the hatch, and the sensors. The controller detects the presence of a delivery device that is configured to carry the packages for delivery into the storage units. The delivery device includes a drone, or an electronic device operated by a delivery agent. The controller verifies the delivery device and opens the hatch to provide access for the delivery device to place the package in the storage units. The controller notifies and authenticates a user to provide access to retrieve the packages from the storage units.

### CROSS-REFERENCE TO RELATED APPLICATIONS

The present application is a continuation-in-part of U.S. application Ser. No. 18/981,410, filed Dec. 13, 2024; which claims benefit of U.S. Provisional Application No. 63/610,450, filed Dec. 15, 2023; all of which are incorporated herein in their entirety and referenced thereto.

### BACKGROUND OF THE INVENTION

### Field of the Invention

The present invention relates to delivering packages. More specifically, the present invention relates to a delivery system having automated and remotely controlled features for secure delivery of packages.

### Description of the Prior Art

With the increase in technology, many people tend to use electronic commerce (e-commerce) sites created by web technology to buy goods or items. The e-commerce sites, often referred to as, online shops allow a person to purchase an item or goods. After purchase, the item is delivered to a designated delivery destination specified by the purchaser. Typically, e-commerce sites use a delivery company to deliver the item at the designated delivery destination. At times, the person intended to receive the item at the designated delivery destination may be away from the designated delivery destination. This results in a missed delivery. In some instances, a representative of the delivery company may leave the item at the doorstep. The item or package left at the doorstep is susceptible to theft or damage. Further, the item may get damaged due to weather conditions.

In order to overcome the above problems, several devices have been proposed in the past. One such attempt is disclosed in a U.S. Pat. No. 11,666,168, entitled “Food delivery receptacle assembly” (“the '168 patent”). The '168 patent discloses a food delivery receptacle assembly for protecting food deliveries including a box in which a set of openings is positioned. A food container can be inserted into the box through a respective opening. Each of a set of panels is hingedly engaged to the box and is positioned to selectively close a respective opening. Insulation is engaged to an inner surface of the box and to an inner face of each panel. The insulation reduces heat transfer between food in the food container and air outside of the box. Each of a set of locks is engaged to the box and is selectively engageable to a respective panel. The locks are electronically actuated to deter unauthorized access to the food container. The locks can be deactivated to permit authorized access to the food container, thus allowing access to the box by a delivery agent and a user.

Another example is disclosed in a U.S. Pat. No. 11,064,831, entitled “Package delivery system and method of use” (“the '831 patent”). The '831 patent discloses a package delivery system including a delivery pod container having a package deposit door positioned at a top of the delivery pod container, the package deposit door providing access to an interior area of the delivery pod container; and a pod door located on a front of the delivery pod container and to provide access to the interior area of the delivery pod container, the pod door having a lock; a bracket attached to the delivery pod container and to engage with a door and mount the delivery pod container thereto; the delivery pod container is to receive the package therein upon delivery from the delivery personnel.

Yet another example is disclosed in a U.S. Pat. No. 10,039,401, entitled “Smart parcel safe” (“the '401 patent”). The '401 patent discloses a smart parcel safe including a container defining an enclosure with an opening, a lid attached to the container by hinges and formed to fit over the opening and securely close the enclosure in a closed orientation, the lid being hinged to move from the closed orientation into an open orientation so as to provide access to the enclosure through the opening, a mobile communication device including an app designed to control locking/unlocking of an associated locking mechanism, and an electronically controlled locking mechanism affixed to the container and the lid, the electronically controlled locking mechanism being associated with the mobile communication device so as to be locked/unlocked in response to operation of the mobile communication device.

Although the above discussed delivery receptacles are useful, they have few problems. For instance, most of the existing delivery receptacles are designed for receiving specific goods such as packages or perishable items. As such, the delivery receptacles used for receiving the packages are not suitable to store the perishable items for a long-time resulting in the perishable items to get spoiled if left unattended. Further, some of the existing delivery receptacles do not offer intended security features and real-time notifications to the owner or intended recipient.

Therefore, there is a need in the art to provide an improved delivery system that is equipped with security features, configured to control internal temperature allowing to protect perishable goods or medications and offer a built-in communication system to notify the intended recipient when a delivery is made.

### SUMMARY OF THE INVENTION

It is an object of the present invention to provide a delivery system that avoids the drawbacks of known delivery receptacles.

It is another object of the present invention to provide a delivery system having multiple housings or receptacles or storage units, each separated by a function and configured to receive food and groceries, and other packages.

It is another object of the present invention to provide a delivery system that is equipped with security features, configured to control internal temperature allowing to protect perishable goods or medications and offer a built-in communication system to notify the intended recipient when a delivery is made.

In order to overcome one or more objects, the present invention presents a delivery system and a method of securely delivering a package. The delivery system includes housings or storage units positioned at a wall or door or roof of a structure.

In one aspect, the housings or storage units are positioned at the wall or door of the structure. The housings or storage units are used for receiving food and groceries, and other packages. Each housing is unlocked separately by a specific security code or Quick Response (QR) code scan via a keypad. When a delivery provider or delivery agent carrying a delivery device (i.e., delivery agent carrying an electronic device) approaches, the delivery system prompts to type in the security code issued at the time of a shipment order. The security code entered is authenticated to allow access to the appropriate housing for delivery drop-off. The delivery system ensures only authorized delivery agents gain access to place the packages and/or food and groceries.

Additionally, the delivery system is split into three compartments, each separated by a function. The upper two compartments are used for food and groceries and the lower compartment is used for packages. The upper compartments are temperature controlled. As such, the owner of the delivery system can set the temperature to keep the item (food and grocery) at a certain temperature until the item is taken out of the compartment.

The delivery system includes an image capturing unit installed above the compartments or housings. The image capturing unit captures images and provides a real-time knowledge of when the delivery is made to the owner or intended recipient and helps to prevent thefts, and present an extra security measure to their home.

The delivery system can be customized to blend it into the tile, wood, or brick surrounding it. The delivery system can be customized to appear as a piece of furniture (elegant armoire, cupboard, cabinet) helping it to blend seamlessly into the home.

In another aspect, the storage units are installed on the roof within a roof overhang compartment. The delivery system includes a hatch operatively connected to the storage units. The hatch is configured to provide access to a storage unit within the roof overhang compartment. The delivery system includes sensors positioned in the storage units. The sensors include pressure sensors, weight sensors, or position sensors. The sensors are configured to detect the presence of a package within a storage unit. The package includes food, groceries, clothing articles, medical supplies, or any other item. The delivery system includes a proximity sensor. Further, the delivery system includes a controller operatively connected to the storage units, the hatch, the sensors, and the proximity sensor. The controller detects the presence of a delivery device in proximity using the proximity sensor. The delivery device is configured to carry the package to deliver into the storage unit. Here, the delivery device includes a drone or unmanned aerial vehicle (UAV). The controller verifies the delivery device and opens the hatch to provide access to the delivery device to place the package in the storage unit. The controller notifies a user upon delivery of the package into the storage unit. The controller authenticates the user to provide access to retrieve the package from the storage unit.

Additionally, the delivery system includes an image capturing unit configured to capture images of the delivery device and/or the package.

Furthermore, the hatch includes a charging panel to charge a battery of the delivery device. Optionally, the delivery system features a docking station having a charging pod to charge the battery of the delivery device. The docking station indicates a location or place for positioning the drone when not in use.

The delivery system utilizing the drone can be used to bypass ground traffic which helps to reduce delivery times. Further, the drone delivery system can be used to eliminate manual package delivery reducing time and cost. Further, the drone delivery system can be used in remote or difficult to reach locations to deliver essential supplies depending on the need. The drone delivery system allows easy tracking of the package delivery. Further, the drone can be charged at delivery stations/hatches or at docking stations enhancing their usage time.

The features and advantages of the invention here will become more apparent in light of the following detailed description of selected embodiments, as illustrated in the accompanying FIGURES. As will be realized, the invention disclosed is capable of modifications in various respects, all without departing from the scope of the invention. Accordingly, the drawings and the description are to be regarded as illustrative in nature.

### BRIEF DESCRIPTION OF THE DRAWINGS

FIG. 1 illustrates an environment in which a delivery system implements, in accordance with one embodiment of the present invention.

FIG. 2 illustrates the delivery system placed at a wall of a structure, in accordance with one exemplary embodiment of the present invention.

FIG. 3 illustrates a block diagram of the delivery system, in accordance with one embodiment of the present invention.

FIG. 4 illustrates a block diagram of the delivery system being operated by a second device based on access code received from a first device, in accordance with one embodiment of the present invention.

FIG. 5 illustrates a block diagram of a server, in accordance with one embodiment of the present invention.

FIG. 6 illustrates a method of securely delivering a package, in accordance with one embodiment of the present invention.

FIG. 7 illustrates an environment in which a delivery system implements, in accordance with one embodiment of the present invention.

FIG. 8 illustrates a block diagram of the delivery system, in accordance with one embodiment of the present invention.

FIG. 9 illustrates a docking station for recharging a drone, in accordance with one embodiment of the present invention.

FIG. 10 illustrates a method of securely delivering a package, in accordance with one embodiment of the present invention.

### DETAILED DESCRIPTION OF THE PREFERRED EMBODIMENT

The following detailed description set forth below in connection with the appended drawings is intended as a description of exemplary embodiments in which the presently disclosed invention may be practiced. The term “exemplary” used throughout this description means “serving as an example, instance, or illustration,” and should not necessarily be construed as preferred or advantageous over other embodiments. The detailed description includes specific details for providing a thorough understanding of the presently disclosed delivery system. However, it will be apparent to those skilled in the art that the presently disclosed invention may be practiced without these specific details. In some instances, well-known structures and devices are shown in functional or conceptual diagram form in order to avoid obscuring the concepts of the presently disclosed delivery system.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present invention provides a description of a delivery system, it is to be further understood that numerous changes may arise in the details of the embodiments of the delivery system. It is contemplated that all such changes and additional embodiments are within the spirit and true scope of this disclosure.

The following detailed description is merely exemplary in nature and is not intended to limit the described embodiments or the application and uses of the described embodiments. All of the implementations described below are exemplary implementations provided to enable persons skilled in the art to make or use the embodiments of the disclosure and are not intended to limit the scope of the disclosure.

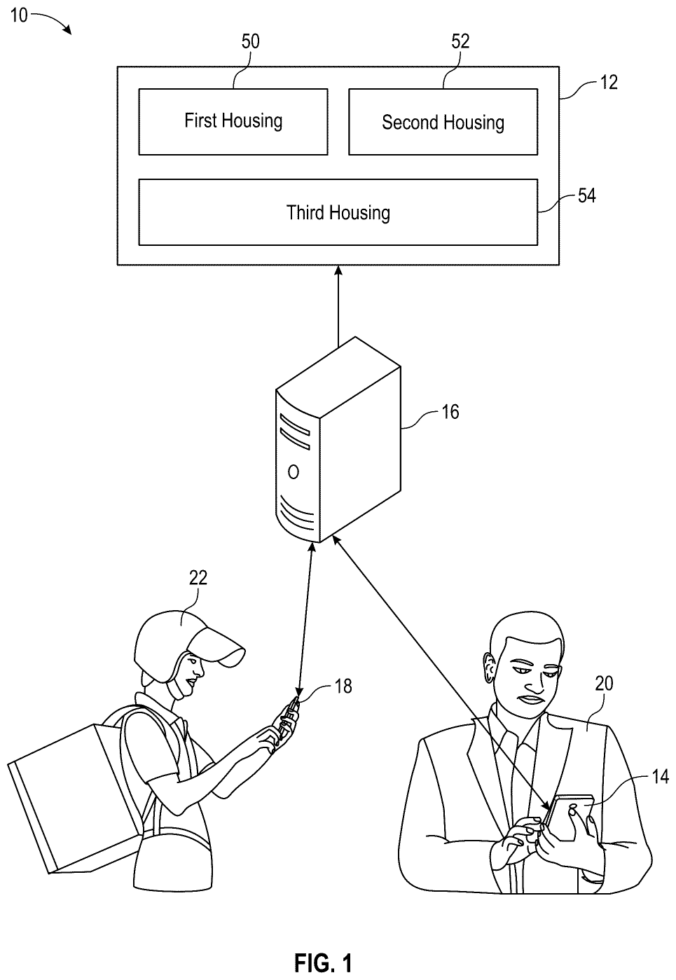

Various features and embodiments of a delivery system for securely delivering a package are explained in conjunction with the description of FIGS. 1-10.

FIG. 1 shows an environment 10 in which a delivery system 12 implements, in accordance with one embodiment of the present invention. Delivery system 12 communicatively connects to a first device 14, a server 16 and a second device 18 via a network (not shown). The network includes a wireless network, a wired network or a combination thereof. The network can be implemented as one of the different types of networks, such as intranet, local area network (LAN), wide area network (WAN), the internet, and the like. The network implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network includes a variety of network devices, including routers, bridges, servers, computing devices, storage devices, and the like.

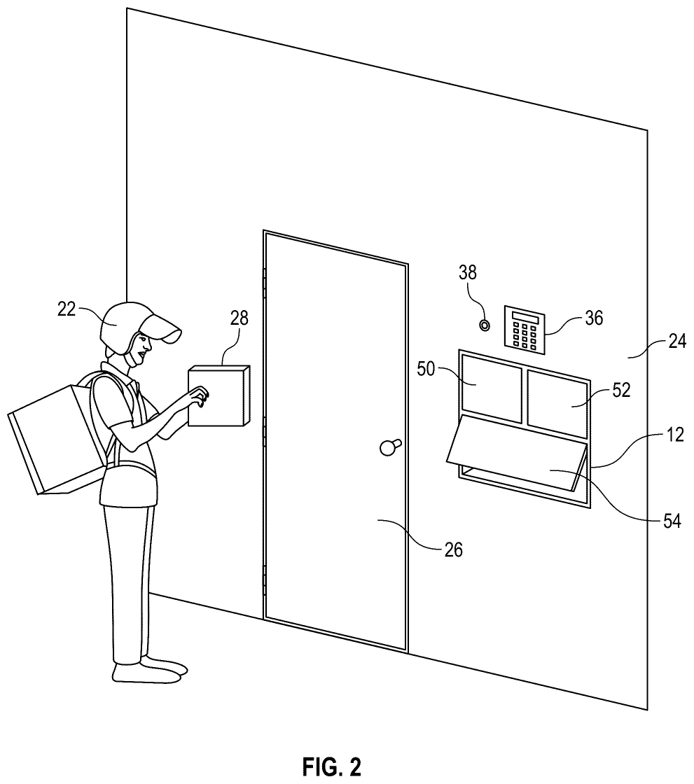

Delivery system 12 installs at a wall 26 or specifically designed cabinet near a door of a structure or home or building 24, as shown in FIG. 2, for example. In one example, delivery system 12 is installed flushing with structure 24 to save space at structure 24. Optionally, delivery system 12 is designed to integrate within the wall of structure 24. First device 14 indicates an electronic device such as a mobile phone, a laptop, a computer, a personal digital assistant device, etc. First device 14 is operated by a first user e.g., owner 20 of structure 24. Second device 18 indicates an electronic device such as a mobile phone, a laptop, a computer, a personal digital assistant device, etc. Second device 18 is operated by a second user 22 i.e., delivery agent of a delivery company. Since second device 18 is used for delivering a package, second device 18 may also be referred to as the delivery device.

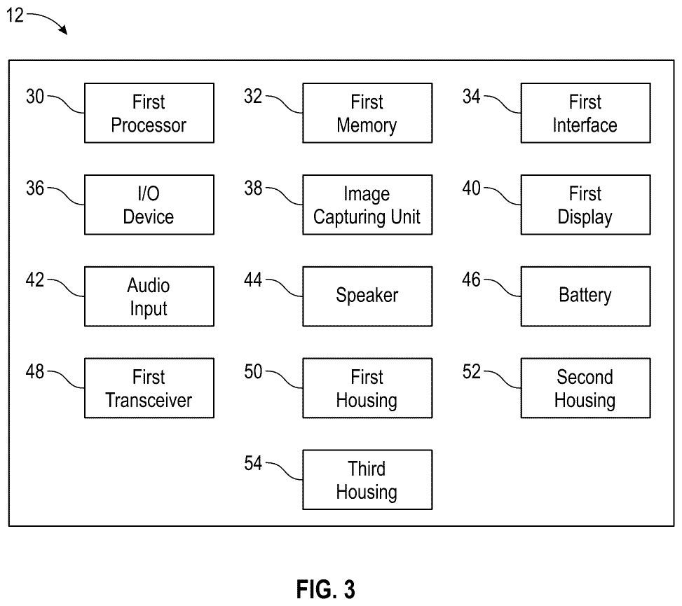

FIG. 3 shows a block diagram of delivery system 12, in accordance with one embodiment of the present invention. Delivery system 12 includes a first processor or first controller 30. First processor 30 includes one or more commonly known CPUs such as a microprocessor or a microcontroller. It should be understood that first processor 30 is responsible for implementing specific functions under the control of software including an operating system, and any appropriate application software. Delivery system 12 includes a first memory 32 such as a volatile memory (e.g., RAM), non-volatile memory (e.g., disk memory, FLASH memory, EPROMs, etc.), unalterable memory, and/or other types of memory. In one implementation, first memory 32 is configured or designed to store data, program instructions. The program instructions control the operation of an operating system and/or one or more applications. Delivery system 12 includes a first interface 34. First interface 34 includes a wired interface and/or a wireless interface. In one implementation, first interface 34 includes functionality similar to at least a portion of functionality implemented by one or more computer system interfaces such as those described herein and/or generally known to one having ordinary skill in the art. Delivery system 12 includes an Input/Output (I/O) device 36 such as a keypad, buttons, toggles, etc.

Further, delivery system 12 includes an image capturing unit 38 such as a camera used to capture image or video of second user 22, or package 28 being placed at delivery system 12. In one example, image capturing unit 38 is positioned adjacent to delivery system 12 (or housing 50, 52, 54) to capture images or videos of package 28 and/or second user 22 at the time of delivery of items. Delivery system 12 includes a first display 40 to display text, digital keypad, image or video. Delivery system 12 includes an audio input 42 such as a microphone to capture the voice of second user 22. Delivery system 12 includes a speaker 44 to produce sounds or for announcing audio instructions.

Delivery system 12 includes a battery 46. Battery 46 indicates a rechargeable battery such as a Lithium Ion (Li-ion) battery. Battery 46 is charged using a cable (not shown) via a charging port (not shown). Optionally, battery 46 is charged wirelessly using inductive charging or charging pad (not shown) as known in the art. Further, delivery system 12 includes a first wireless communication module(s)/transceiver 48. First transceiver 48 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

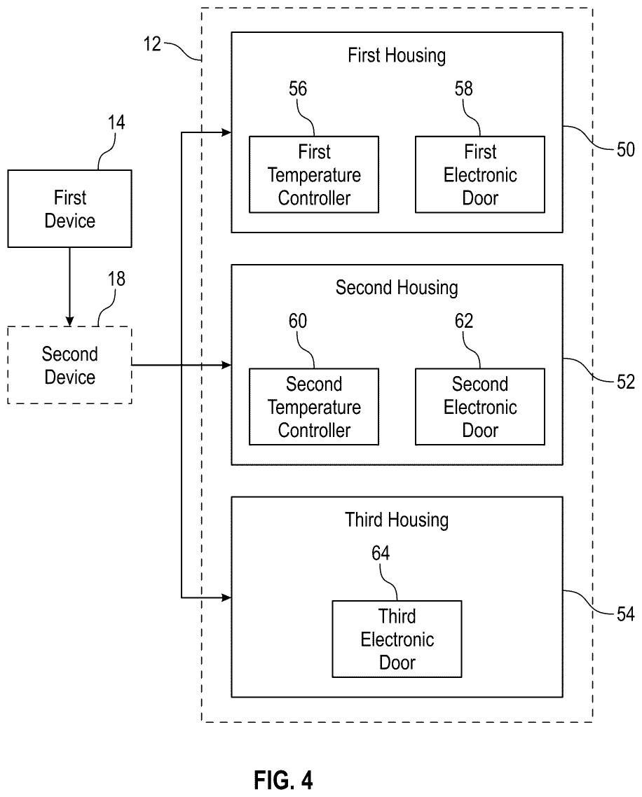

In the present invention, delivery system 12 includes three housings or storage units such as a first housing or first storage unit 50, a second housing or second storage unit 52 and a third housing or third storage unit 54. Each housing indicates a container or compartment or receptacle or storage box. In one embodiment, first housing 50 and second housing 52 positions adjacent to each other and third housing 54 positions below first housing 50 and second housing 52, as can be seen from FIG. 1 and FIG. 2. As can be seen, third housing 54 is larger in size than first housing 50 and second housing 52. In one example, first housing 50 includes a first temperature controller 56, as shown in FIG. 4. First temperature controller 56 helps to maintain temperature inside first housing 50. Further, first housing 50 includes a first electronic door or first electronic hatch 58. First processor 30 controls the operation of first electronic door 58 to provide access or restrict to first housing 50. Similarly, second housing 52 includes a second temperature controller 60. Second temperature controller 60 helps to maintain temperature inside second housing 52. Further, second housing 52 includes a second electronic door or second electronic hatch 62. First processor 30 controls the operation of second electronic door 62 to provide access or restrict to second housing 52. Further, third housing 54 includes a third electronic door or third electronic hatch 64. First processor 30 controls the operation of second electronic door 62 to provide access or restrict to second housing 52.

In one example, first temperature controller 56 and second temperature controller 60 help to heat and/or refrigerate first housing 50 and second housing 52, respectively with variable temperatures such that first user 20 may set the temperature of first housing 50 and second housing 52 between 32 and 158 degrees Fahrenheit separately. This presents first user 20 with the ability to pre-set, activate, and isolate first housing 50 and second housing 52 based on the type of item(s) being stored remotely. In one example, first housing 50 allows storing food items such as pizza, wings, and other ordered foods in a pre-set temperature once they are placed inside. First housing 50 having first temperature controller 56 allows food to be ordered and delivered before anyone is home and prevents first user 20 or other occupants of structure 24 from having to rush after school, work, etc. in order to keep their food from getting cold. In another example, second housing 52 allows storing perishable items such as groceries. Here, second temperature controller 60 allows maintaining the temperature of groceries at pre-set temperature such that items can be stored while first user 20 or other occupants of structure 24 are away. Once occupants of structure 24 arrive, they move the groceries from second housing 52 into a main refrigerator (not shown) without having to worry about their food or groceries spoiling if not reached and put away immediately. Third housing 54 positions below first housing 50 and second housing 52 and is configured to receive packages 28, say delivery of physical goods such as clothing articles, books, food items, or any other items.

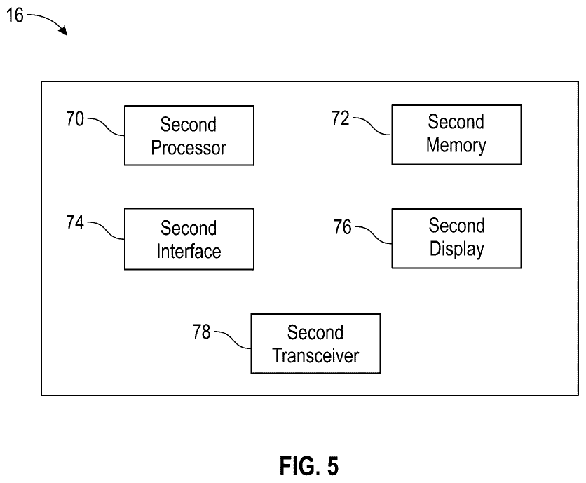

FIG. 5 shows a block diagram of server 16, in accordance with one embodiment of the present invention. Server 16 encompasses a second processor 70. Second processor 70 includes one or more commonly known CPUs such as a microprocessor or a microcontroller. It should be understood that second processor 70 is responsible for implementing specific functions under the control of software including an operating system, and any appropriate applications software. Server 16 includes a second memory 72 connected to second processor 70 via a data bus (not shown). Second memory 72 includes a volatile memory and/or a non-volatile memory. Preferably, second memory 72 stores program instructions or software programs that interact with the other devices such as server 16 as described below. In one implementation, second processor 70 executes the program instructions stored in second memory 72 in any suitable manner. In one implementation, second memory 72 stores digital data indicative of documents, files, programs, web pages, etc. retrieved from server 16.

Server 16 includes a second interface 74. Second interface 74 includes a wired interface and/or a wireless interface. In one implementation, second interface 74 includes functionality similar to at least a portion of functionality implemented by one or more computer system interfaces such as those described herein and/or generally known to one having ordinary skill in the art. In some examples, server 16 includes a second display 76. Further, server 16 includes a second wireless communication module(s)/transceiver 78. Second transceiver 78 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

In accordance with the present invention, first device 14 accesses server 16 to purchase an item through an electronic commerce (e-commerce) site using an application. Similarly, second device 18 includes an application for receiving a service request for delivering the item at a designated delivery destination i.e., home 24 of first user 20. In order to purchase the item, at first, first user 20 registers with server 16 using his/her name, physical address, electronic mail (email) and identification number (ID). Further, first user 20 registers his/her first device 14. After registering, server 16 generates a unique user ID for first user 20 and/or first device 14. Similarly, second user 22 registers with server 16 using his/her name, physical address, employee/service provider identification number (ID), etc. Further, second user 22 registers his/her second device 18. After registering, server 16 generates a unique service provider ID for second user 22 and/or second device 18.

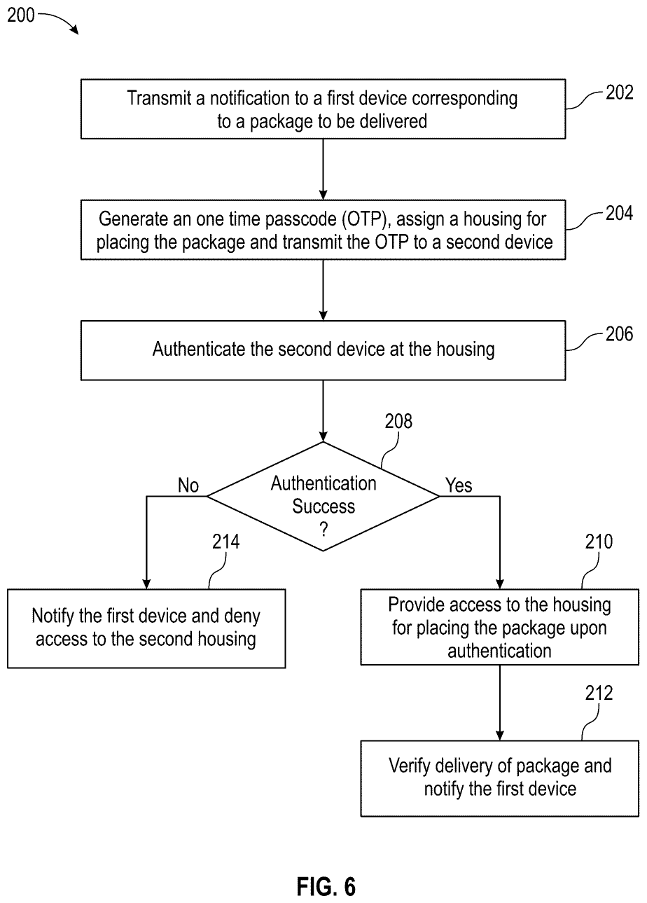

Now referring to FIG. 6, a method 200 of securely delivering a package is explained with the help of FIG. 4, in accordance with one exemplary embodiment of the present invention. The order in which method 200 is described should not be construed as a limitation, and any number of the described method blocks can be combined in any order to implement method 200 or alternate methods. Additionally, individual blocks may be deleted from method 200 without departing from the spirit and scope of the invention described herein. Furthermore, method 200 can be implemented in any suitable hardware, software, firmware, or combination thereof. However, for ease of explanation, in the embodiments described below, method 200 may be implemented using the above-described delivery system 12 and server 16.

Method 200 starts at step 202. At step 202, first user 20 purchases an item at an e-commerce site via server 16. Here, first user 20 purchases the item and makes the payment. First user 20 makes the payment and provides a designated delivery destination to deliver the item. Once the order is ready to be shipped, server 16 transmits a notification to first user 20 at first device 14. Concurrently or consecutively, server 16 assigns second user 22 for delivering the item at the designated delivery destination. In one example, first user 20 determines a housing i.e., one of first housing 50, second housing 52 and third housing 54 to be used for delivering the item. As specified above, first user 20 determines the housing to be used for delivery of the item based on the type of item ordered. Considering the above example, once first user 20 selects the housing, say third housing 54 for delivering the item, then first user 20 has an option of generating a one-time passcode (OTP) to be shared with second user 22 for accessing third housing 54. In another example, server 16 generates the OTP or any other security code for second user 22 for accessing third housing 54. After generating the OTP, server 16 transmits the OTP to second device 18, as shown at step 204. At step 206, second device 18 is authenticated when second user 22 reaches delivery system 12. Upon reaching, delivery system 12 prompts second user 22 to enter the OTP or scan the QR code in order to authenticate second device 18. In one example, delivery system 12 prompts second user 22 with a numeric keypad to authenticate second device 18. In another example, delivery system 12 prompts second user 22 with a quick response (QR) to authenticate. Upon entering OTP or scanning the QR code, delivery system 12 transmits the OTP to server 16 for verifying whether the OTP entered matches with the OTP generated, as shown at step 208. If the OTP matches, then method 200 moves to step 210. At step 210, delivery system 12 receives a confirmation notification from server 16 and provides access to third housing 54. Here, delivery system 12 prompts third electronic door 64 to open such that second user 22 can place the item in third housing 54. In case the item to be delivered is food item in first housing 50, then first user 20 defines the temperature to be set inside first housing 50 for maintaining the temperature inside first housing 50 to keep the food fresh.

In one example, electronic doors or electronic hatches 58, 62, 64 are equipped with electronic mechanical locks that only open “one way”. In other words, electronic doors or electronic hatches 58, 62, 64 include inside or interior locks that cannot be unlocked until all of the exterior (outside the home) compartments are closed and vice versa. This prevents home invasion should an exterior threat attempt to target delivery system 12 as a means to break in. Additionally, this strategically prevents unwarranted access from vulnerable individuals within the home such as children, senior citizens, or unsuspecting guests that could be injured via heat, cold, or mechanical injury from delivery system 12 itself.

After second user 22 places the item, first processor 30 prompts image capturing unit 38 to capture an image of the item in the housing. In one example, first processor 30 prompts image capturing unit 38 to capture an image of second user 22 while he/she is delivering the item in the housing (third housing 54). Subsequently, first processor 30 employs third electronic door 64 to close indicating that the item has been securely placed in third housing 54. Subsequently, delivery system 12 notifies server 16 that the item has been delivered. Further, server 16 notifies first user 20 at first device 14 that the item has been delivered, as shown at step 212. In accordance with the present invention, delivery system 12 transmits live images or video captured by image capturing unit 38 to first device 14 via server 16, from the time image capturing unit 38 captures presence of second device 18 in proximity to delivery system 12 and until second user 22 completes the delivery.

If the OTP entered or QR code scanned does not match with the OTP/QR code generated at step 208, then method 200 moves to step 214. At step 214, delivery system 12 presents a notification on first display 40 that OTP/QR code entered has failed. Further, delivery system 12 notifies server 16 of incorrect OTP and the same is notified to first user 20 on first device 14. Transmission of failed authentication notification ensures unauthorized personnel from accessing delivery system 12.

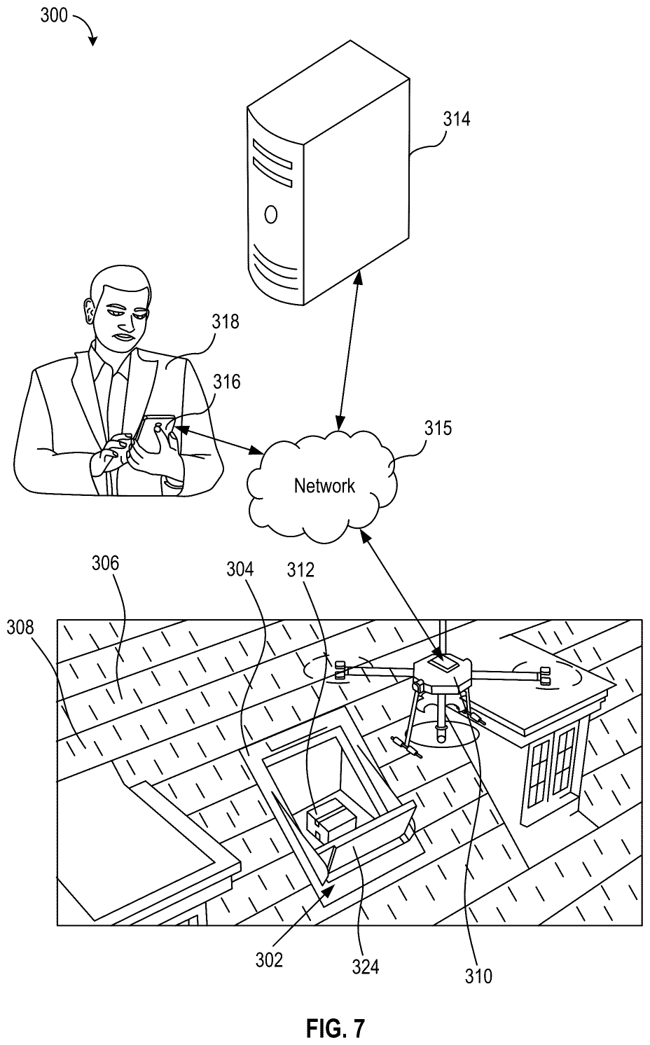

Referring to FIG. 7, an environment 300 in which a delivery system 302 is implemented is shown, in accordance with one embodiment of the present invention. Delivery system 302 installs at a roof overhang compartment or simply overhang compartment 304 provided at a rooftop or roof 306 of a structure or building 308. In some implementations, delivery system 302 may have a unique code or number to identify it. The unique code may include the location associated with delivery system 302 i.e., the location of structure 308. Overhang compartment 304 may be specially designed in an existing structure 308 or removably attached to structure 308 depending on the need. In the present embodiment, delivery system 302 includes an unmanned aerial vehicle (UAV) or drone 310 used to deliver one or more packages 312 into overhang compartment 304. Since drone 310 is used for delivering packages 312, drone 310 may also be referred to as a delivery device. Each drone 310 may have a Unique Identification Number (UID) to identify, track and manage drone 310 within the airspace. Packages 312 include, but not limited to, clothing articles, books, groceries, food items, medical supplies, safety equipment, emergency equipment, or any other items.

Drone 310 communicatively connects to a server 314 via a network 315. Server 314 operates similar to server 16, explained above. Server 314 is managed and operated by a logistic company or service provider or an aggregator or an e-commerce company that provides courier, package delivery, etc. Network 315 includes a wireless network, a wired network or a combination thereof. Network 315 can be implemented as one of the different types of networks, such as intranet, local area network (LAN), wide area network (WAN), the internet, and the like. Network 315 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, network 315 includes a variety of network devices, including routers, bridges, servers, computing devices, storage devices, and the like.

In the present embodiment, an owner or user 318 of structure 308 or intended recipient of packages 312 may subscribe or avail services offered by the logistic company to deliver packages 312 to his/her home or office (structure 308). For instance, user 318 may order an item, say a clothing article through an e-commerce website using a user device 316 and utilize the logistic company to deliver package 312 to his/her home via drone 310.

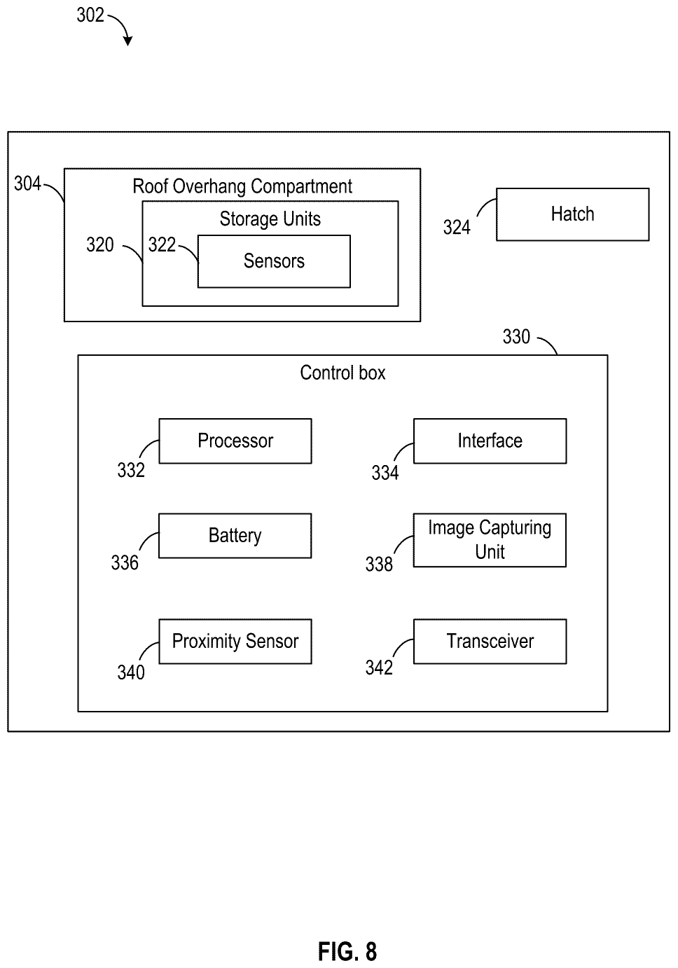

Now referring FIG. 8, a block diagram of delivery system 302 is shown, in accordance with one embodiment. As specified above, delivery system 302 includes one or more overhang compartments 304 at rooftop 306 of structure 308. Each overhang compartment 304 may include one or more storage units 320. Storage unit 320 indicates a container or housing (say first housing 50, as explained above) used to store packages 312. Storage unit 320 may be provided at appropriate locations enabling user 318 to retrieve packages 312 once it is delivered. In one example, only one storage unit 320 might be aligned with overhang compartment 304. In another example, two or more storage units 320 might be arranged (stacked) one over another or in a side-by-side manner. By arranging two or more storage units 320 in a stacking or side-by-side manner, storage units 320 allow to receive several packages 312 at a single instance or multiple instances depending on the need.

Each storage unit 320 includes sensors 322. Sensors 322 are placed at appropriate places within or outside of storage unit 320. Sensors 322 include pressure sensors, weight sensors or position sensors. For instance, the pressure sensors are configured to detect the presence of package 312 in storage unit 320 based on its size, capacity, etc. Here, the pressure sensors may measure the difference in pressure between two points and detect the presence of package 312 by the change in pressure package 312 creates within storage unit 320 when package 312 occupies space. The weight sensors are configured to measure the weight of package 312. The position sensors are configured to detect the position/location of package 312 within storage unit 320. This allows determining the amount of space utilized or occupied by package 312 within storage unit 320. In some implementations, sensors 322 include temperature sensors to determine the temperature of storage units 320. This information may be used to modify the refrigeration and heating of storage units 320 to store packages 312 of different nature, such as food.

Overhang compartment 304 includes a hatch 324 configured to provide access to storage units 320. Hatch 324 hingedly connects to overhang compartment 304. In one example, hatch 324 is manually operated by user 318. In another example, hatch 324 is remotely operated by user 318. In some implementations, hatch 324 is operated upon authenticating drone 310 to access overhang compartment 304 and/or storage unit 320 to deliver package 312 in storage unit 320.

In one embodiment, delivery system 302 includes a control box 330. Control box 330 contains electronic components required to operate delivery system 302. Control box 330 positions at or within overhang compartment 304 or storage unit 320. In one example, control box 330 includes a processor or controller 332, an interface 334, a battery 336, an image capturing unit 338, a proximity sensor 340, and a transceiver 342. Processor 332 includes a microprocessor capable of executing program instructions. Interface 334 includes a wired interface and/or a wireless interface. In one implementation, interface 334 includes functionality similar to at least a portion of functionality implemented by one or more computer system interfaces such as those described herein and/or generally known to one having ordinary skill in the art. Delivery system 302 includes an Input/Output (I/O) device such as a keypad, buttons, toggles, etc.

Battery 336 includes a rechargeable battery such as a Lithium Ion (Li-ion) battery. Battery 336 is charged using a cable (not shown) via a charging port (not shown). Optionally, battery 336 is charged wirelessly using inductive charging or charging pad (not shown) as known in the art. Image capturing unit 338 includes a camera configured to capture image or video of drone 310, and/or package 312. Proximity sensor 340 is configured to detect the presence of nearby drone 310. In the present invention, proximity sensor 340 detects the presence of drone 310 nearby and notifies processor 332. Processor 332 authenticates drone 310 and instructs hatch 324 to open so that drone 310 can deliver package 312 in storage unit 320. Transceiver 342 is configured to communicate with external devices using one or more wireless interfaces/protocols such as, for example, 802.11 (Wi-Fi), 802.15 (including Bluetooth™), 802.15 (Wi-Max), 802.22, Cellular standards such as CDMA, CDMA2000, WCDMA, Radio Frequency (e.g., RFID), Infrared, Near Field Magnetics, etc.

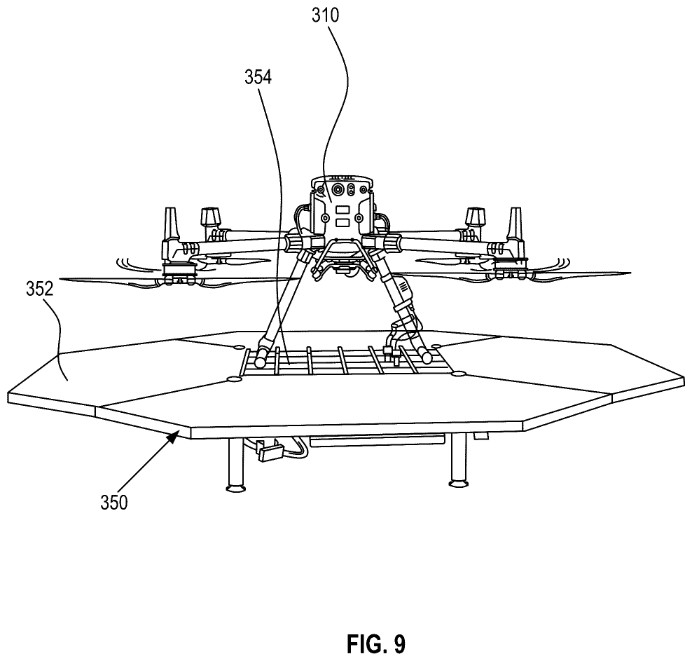

In some implementations, drone 310 is configured to position at a docking station 350, as shown in FIG. 9, for example. Docking station 350 indicates a location or place to position drone 310 when it is not in use. In one example, docking station 350 may include a location of the logistic company delivering package 312. In another example, docking station 350 may include a location of a fulfillment center that receives and stores packages 312 before they are delivered to the user's location. The fulfillment center may be operated by the logistic company or the e-commerce company. In yet another example, docking station 350 may include a rooftop of other users or subscribers who allowed permission to the logistic company to use their building to park drones 310 when they are not in use. By allowing drones 310 to be stationed at appropriate locations, the time required to deliver packages 312 at delivery system 302 installed at the user's location is reduced and the cost for delivering each package 312 is minimized. Docking station 350 may include one or more platforms 352 to receive one or more drones 310 when they are not in use. Each platform 352 may have a charging pod 354 configured to charge a battery (not shown) of drone 310.

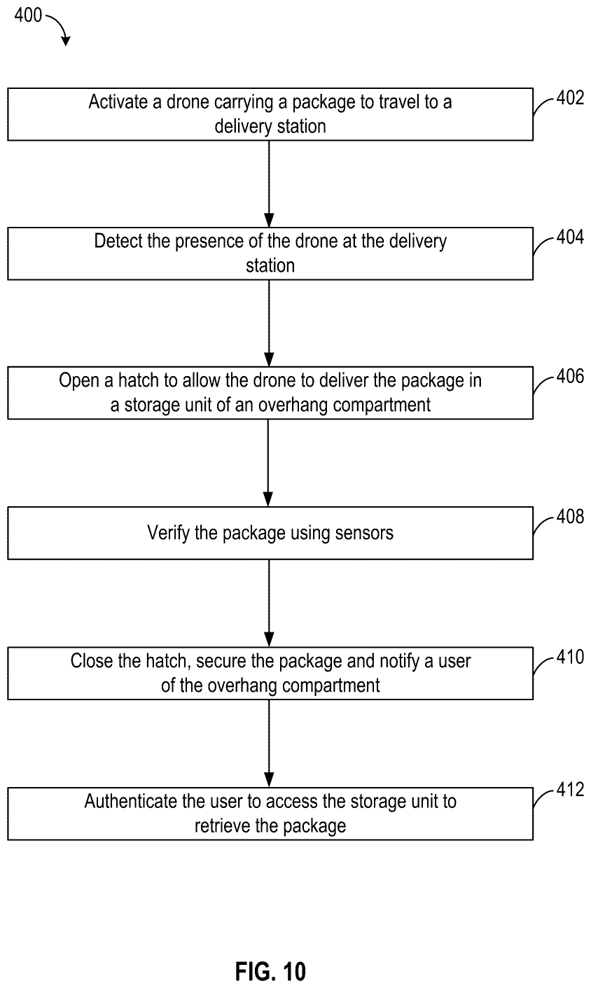

Now referring to FIG. 10, method 400 of securely delivering a package is explained with the help of FIG. 7, FIG. 8, and FIG. 9, in accordance with one exemplary embodiment of the present invention. The order in which method 400 is described should not be construed as a limitation, and any number of the described method blocks can be combined in any order to implement method 400 or alternate methods. Additionally, individual blocks may be deleted from method 400 without departing from the spirit and scope of the invention described herein. Furthermore, method 400 can be implemented in any suitable hardware, software, firmware, or combination thereof. However, for ease of explanation, in the embodiments described below, method 400 may be implemented using the above-described delivery system 302 and server 314.

The delivery process begins when user 318 purchases an item at an e-commerce site via server 314. Here, user 318 purchases the item and provides a designated delivery destination or delivery station (user's location i.e., where delivery system 302 is installed) to deliver the item/package 312. Once the order is ready to be shipped, server 314 transmits a notification to user 318 on his/her user device 316. Concurrently or consecutively, server 314 identifies drone or delivery device 310 that can pick up package 312 and deliver at the delivery station. In some implementations, server 314 transmits the UID of drone 310 to user device 316 such that user 318 may link it with delivery system 302. In one example, server 314 may anonymize the UID of drone 310 to prevent user 318 from accessing critical information of drone 310.

Upon identifying drone or delivery device 310, server 314 activates drone 310 and transmits instructions to pick up package 312 from the fulfillment center. Subsequently, server 314 provides the location coordinates of the delivery station to deliver package 312, as shown at step 402. Once drone or delivery device 310 reaches the delivery station i.e., the location of delivery system 302, proximity sensor 340 detects the presence of drone 310, as shown at step 404. Here, proximity sensor 340 sends a signal to processor 332. Processor 332 may verify the UID of drone 310. Upon verifying, processor 332 instructs hatch 324 to open, as shown in step 406. Opening hatch 324 provides a clear and unobstructed pathway for drone 310 to access storage unit 320. Subsequently, drone 310 delivers package 312 in storage unit 320. As specified above, delivery system 302 can be configured to have one or more storage units 320. User 318 may provide instructions to deliver package 312 in a particular storage unit 320. Optionally, drone 310 may deliver package 312 in the topmost storage unit 320. Once delivered, delivery system 302 may configure another storage unit 320 to be positioned at the top such that subsequent packages 312 can be delivered into it.

After drone 310 delivers package 312 in storage unit 320, processor 332 activates sensors 322 to verify the presence of package 312, as shown at step 408. In one example, sensors 322 may verify the presence, weight and height of package 312. Considering that sensors 322 detect the presence of package 312 in storage unit 320, sensors 322 notify processor 332 indicating that drone 310 has fully released package 312 and it is clear to close hatch 324. Subsequently, processor 332 closes hatch 324 securing package 312 in storage unit 320. In one example, processor 332 instructs storage units 320 such that the lowest available storage unit 320 within stacked storage units 320 stores package 312 allowing the topmost storage unit 320 to be free for receiving another package 312.

Additionally, processor 332 notifies user 318 on his/her user device 316 that package 312 has been delivered in storage unit 320 of delivery system 302, as shown at step 410. When user 318 wishes to retrieve package 312, processor 332 may authenticate user 318 before allowing him/her to access storage unit 320, as shown at step 412. User 318 might be authenticated using his/her biometric information stored or using one-time passcode (OTP) or any other known methods. This helps to protect individuals within homes from accessing package 312 and also thwart attempts by thieves at home entry.

After delivering package 312, drone 310 may travel back to docking station 350 to deliver another package 312 at another delivery system 302 or to charge its battery. In some implementations, hatch 324 may include a charging panel (not shown). The charging panel allows recharging the battery of drone 310 before their return journey.

The presently disclosed delivery system 302 can be managed by an application on user device 316. User 318 can order, manage and return packages 312, send confidential access codes to trusted third parties to pick up packages 312. Delivery system 302 can be implemented by home, business, commercial owners or military branch owners that want the fastest available form of delivery. Delivery system 302 has several advantages over traditional delivery methods. For example, delivery system 302 avoids inefficient or indirect delivery routes, bypassing difficult terrain or landscape. Delivery system 302 offers increased accessibility, and improved customer satisfaction due to quicker order fulfillment. As such, delivery system 302 can be used to deliver any items including medical supplies, emergency equipment, or rapid response in emergency situations when immediate assistance is needed. In some scenarios, delivery system 302 may also be used to deliver military hardware in areas where it is difficult to access, enhancing safety and security of people. Further, delivery system 302 can be configured to deliver hazardous material, medical and fire suppressants during emergency situations. In some examples, delivery system 302 can be made with steel-reinforced material for added security and to ensure no unauthorized third-party can break-in through delivery system 302 in itself to enter the home. Exterior of delivery system 302 is made weatherproof to help prevent unnecessary damage and withstand harsh weather conditions.

A person skilled in the art appreciates that the delivery system can come in a variety of shapes and sizes depending on the need and comfort of the user. Further, many changes in the design and placement of components may take place without deviating from the scope of the presently disclosed delivery system.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A delivery system for securely delivering a package, said delivery system comprising:
a plurality of storage units configured to store packages;
a hatch operatively connected to said plurality of storage units, wherein said hatch is configured to provide access to a storage unit of said plurality of storage units;
sensors positioned in said storage units, wherein said sensors are configured to detect presence of a package of said packages in said storage unit of said plurality of storage units; and
a controller operatively connected to said plurality of storage units, said hatch, and said sensors,
wherein said controller detects proximity of a delivery device,
wherein said delivery device is configured to carry said packages to deliver into said plurality of storage units, and
wherein said controller verifies said delivery device and opens said hatch to provide access to said delivery device to place said package in said storage unit.

2. The delivery system of claim 1, wherein said delivery device comprises one of a drone and an electronic device operated by a delivery agent.

3. The delivery system of claim 1, further comprises an image capturing unit configured to capture images of said delivery device and/or said package.

4. The delivery system of claim 1, wherein said storage unit comprises a temperature controller to maintain temperature of said storage unit.

5. The delivery system of claim 1, wherein said plurality of storage units is installed at a wall of a structure.

6. The delivery system of claim 1, wherein said plurality of storage units is installed at a roof of a structure, and wherein said delivery device comprises a drone.

7. The delivery system of claim 1, wherein said sensors comprise one of pressure sensors, weight sensors, and/or position sensors.

8. The delivery system of claim 6, wherein said hatch comprises a charging panel to charge a battery of said drone.

9. The delivery system of claim 2, further comprises a proximity sensor configured to detect the presence of said drone in proximity to said delivery system.

10. The delivery system of claim 1, wherein said controller verifies said delivery device using one of biometric information, a quick response (QR) code, a one-time passcode (OTP), and a unique identification number of said delivery device.

11. The delivery system of claim 1, wherein said controller notifies a user upon delivery of said package in said storage unit.

12. The delivery system of claim 11, wherein said controller authenticates said user to provide access to said user to retrieve said package from said storage unit.

13. A delivery system for securely delivering a package, said delivery system comprising:
a plurality of storage units configured to store packages, wherein said plurality of storage units is installed at a roof of a structure;
a hatch operatively connected to said plurality of storage units, wherein said hatch is configured to provide access to a storage unit of said plurality of storage units;
sensors positioned in said storage units, said sensors configured to detect presence of a package of said packages in said storage unit of said plurality of storage units;
a proximity sensor; and
a controller operatively connected to said plurality of storage units, said hatch, said sensors, and said proximity sensor,
wherein said controller detects proximity of a delivery device in proximity to said delivery system using said proximity sensor,
wherein said delivery device is configured to carry said packages to deliver into said plurality of storage units, and
wherein said controller verifies said delivery device and opens said hatch to provide access to said delivery device to place said package in said storage unit.

14. The delivery system of claim 13, wherein said delivery device comprises a drone.

15. The delivery system of claim 13, further comprises an image capturing unit configured to capture images of said delivery device and/or said package.

16. The delivery system of claim 13, wherein said sensors comprise one of pressure sensors, weight sensors, and/or position sensors.

17. The delivery system of claim 13, wherein said hatch comprises a charging panel to charge a battery of said delivery device.

18. The delivery system of claim 13, wherein said controller notifies a user upon delivery of said package in said storage unit, and wherein said controller authenticates said user to provide access to said user to retrieve said package from said storage unit.

19. A method of securely delivering a package, said method comprising the steps of:
providing a plurality of storage units configured to store packages;
providing a hatch operatively connected to said plurality of storage units, said hatch being configured for providing access to a storage unit of said plurality of storage units;
providing sensors positioned in said storage units, said sensors configured for detecting presence of a package of said packages in said storage unit of said plurality of storage units;
providing a controller operatively connected to said plurality of storage units, said hatch, and said sensors;
detecting proximity of a delivery device using said controller, said delivery device being configured for carrying said packages to deliver into said plurality of storage units; and
verifying said delivery device and opening said hatch, by said controller, for providing access to said delivery device for placing said package in said storage unit.

20. The method of claim 19, further comprising:
notifying a user upon delivery of said package in said storage unit; and
authenticating said user for providing access to said user for retrieving said package from said storage unit.
